(19) United States
(12) Patent Application Publication
(10) Pub. No.: US 2026/0124675 A1
(43) Pub. Date: May 7, 2026

(54) MONITORING DEVICE AND MONITORING METHOD

(71) Applicant: TOYOTA JIDOSHA KABUSHIKI KAISHA, Toyota-shi (JP)

(72) Inventor: Tomohiro KOYAMA, Toyota-shi (JP)

(73) Assignee: TOYOTA JIDOSHA KABUSHIKI KAISHA, Toyota-shi (JP)

(21) Appl. No.: 19/363,924

(22) Filed: Oct. 21, 2025

(30) Foreign Application Priority Data
Nov. 1, 2024 (JP) 2024-192633

(51) Int. Cl. B22D 17/32; G01P 15/00

(52) U.S. Cl. CPC B22D 17/32; G01P 15/00

(57) ABSTRACT

A monitoring device includes an acquisition unit configured to acquire acceleration information of a plunger during an injection operation, a determination unit configured to determine presence of an abnormality in a drive mechanism that drives the plunger in a case where a variation width of an acceleration of the plunger in a traveling direction exceeds a value that is predetermined and in a case where a variation frequency of the acceleration of the plunger in the traveling direction includes a component of a frequency that is predetermined, and an output unit configured to output a determination result of the determination unit.

### CROSS-REFERENCE TO RELATED APPLICATION

This application claims priority to Japanese Patent Application No. 2024-192633 filed on November 1, 2024. The disclosure of the above-identified application, including the specification, drawings, and claims, is incorporated by reference herein in its entirety.

### BACKGROUND

### 1. Technical Field

The present disclosure relates to a monitoring device and a monitoring method.

### 2. Description of Related Art

An injection molding machine, also referred to as a die casting machine, is required to detect various abnormalities that affect the injection of a molten metal by a plunger and to quickly repair the abnormalities in order to provide a high-quality molded product. A technique related to the die casting machine is disclosed in, for example, Japanese Unexamined Patent Application Publication No. 2020-138209 (JP 2020-138209 A).

A die casting machine disclosed in JP 2020-138209 A includes acceleration sensors that are capable of detecting an acceleration in three axial directions and provided on a plunger sleeve and at least one of a plunger tip or a plunger rod. Chatter (vibration) generated due to galling (abrasion) of the plunger sleeve or the plunger tip is detected from accelerations in a vertical direction detected by the acceleration sensors.

### SUMMARY

The abnormalities that affect the injection of the molten metal by the plunger include not only the galling but also an abnormality of a drive mechanism that drives the plunger. However, in JP 2020-138209 A, abnormalities other than the galling, among the abnormalities that affect the injection of the molten metal by the plunger, cannot be detected.

The present disclosure has been made in view of the above background, and provides a monitoring device and a monitoring method capable of specifying a location where an abnormality that affects injection of a molten metal by a plunger occurs.

A monitoring device according to the present disclosure includes: an acquisition unit configured to acquire acceleration information of a plunger during an injection operation; a determination unit configured to determine presence of an abnormality in a drive mechanism that drives the plunger when both of the following conditions are satisfied: a variation width of an acceleration of the plunger in a traveling direction exceeds a value that is predetermined, and a variation frequency of the acceleration of the plunger in the traveling direction includes a component of a frequency that is predetermined; and an output unit configured to output a determination result of the determination unit.

The monitoring device according to the present disclosure can accurately detect the abnormality of the drive mechanism that drives the plunger. That is, the monitoring device according to the present disclosure can detect abnormalities other than galling, among abnormalities that affect the injection of the molten metal by the plunger. Since the injection molding machine can perform the repair of an abnormality location as necessary based on a monitoring result of the monitoring device according to the present disclosure, a high-quality molded product can be provided.

A monitoring method according to the present disclosure includes: acquiring acceleration information of a plunger during an injection operation; determining presence of an abnormality in a drive mechanism that drives the plunger when both of the following conditions are satisfied: a variation width of an acceleration of the plunger in a traveling direction exceeds a value that is predetermined, and a variation frequency of the acceleration of the plunger in the traveling direction includes a component of a frequency that is predetermined; and outputting a result of the determining.

The monitoring method according to the present disclosure can accurately detect the abnormality of the drive mechanism that drives the plunger. That is, the monitoring method according to the present disclosure can detect abnormalities other than galling, among abnormalities that affect the injection of the molten metal by the plunger. Since the injection molding machine can perform the repair of an abnormality location as necessary based on a monitoring result in the monitoring method according to the present disclosure, a high-quality molded product can be provided.

According to the present disclosure, it is possible to provide a monitoring device and a monitoring method capable of specifying a location where an abnormality that affects the injection of the molten metal by the plunger occurs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing the injection molding machine to which the monitoring device according to the present disclosure is applied;

FIG. 2 is a schematic cross-sectional view showing the injection molding machine to which the monitoring device according to the present disclosure is applied;

FIG. 3 is a block diagram showing a configuration example of the monitoring device according to the present disclosure;

FIG. 4 is a waveform diagram showing an acceleration of a plunger in a case where there is an abnormality in a drive mechanism;

FIG. 5 is a waveform diagram showing an acceleration of the plunger in a case where there is no abnormality in the drive mechanism;

FIG. 6 is an enlarged waveform diagram showing a part of the acceleration of the plunger in a case where there is an abnormality in the drive mechanism;

FIG. 7 is an enlarged waveform diagram showing a part of the acceleration of the plunger in a case where there is no abnormality in the drive mechanism;

FIG. 8 is a diagram showing a frequency spectrum of each acceleration measurement period in a case where there is an abnormality in the drive mechanism;

FIG. 9 is a diagram showing a frequency spectrum of each acceleration measurement period in a case where there is no abnormality in the drive mechanism; and

FIG. 10 is a flowchart showing an operation of the monitoring device according to the present disclosure.

### DETAILED DESCRIPTION OF EMBODIMENTS

Hereinafter, embodiments will be described referring to the drawings. Note that, since the drawings are drawn in a simplified manner, the technical scope of the embodiments should not be narrowly interpreted based on the description of the drawings. The same elements are represented by the same reference numerals and redundant description will not be repeated.

### Configuration of Injection Molding Machine 1

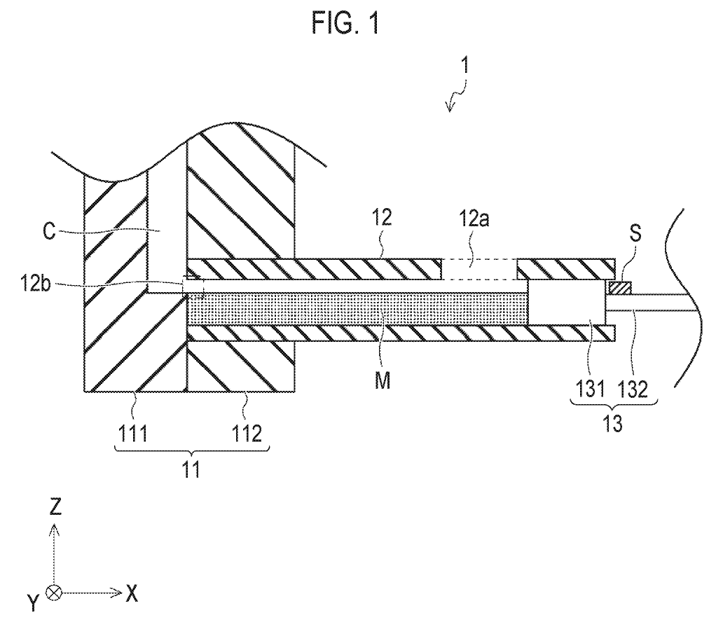

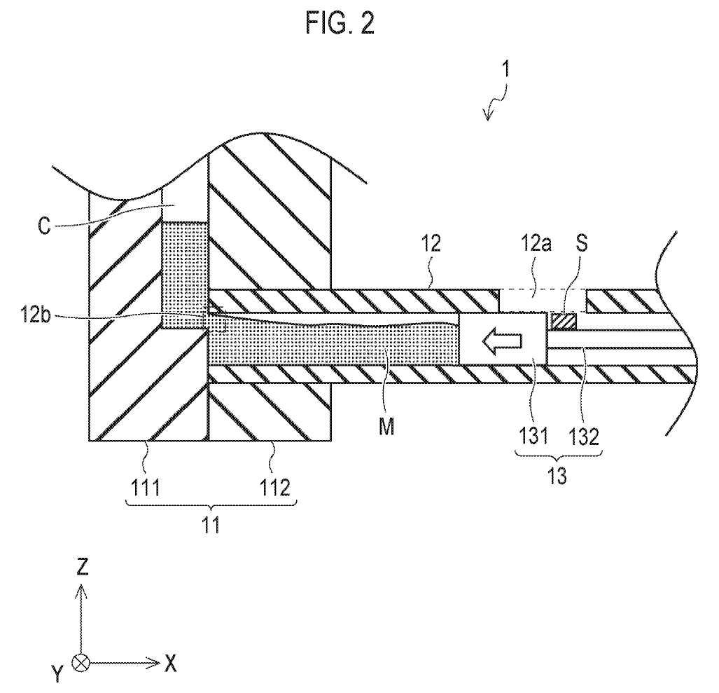

First, a configuration of an injection molding machine to which a monitoring device according to the present disclosure is applied will be described with reference to FIGS. 1 and 2. FIGS. 1 and 2 are schematic cross-sectional views showing the injection molding machine 1 to which the monitoring device according to the present disclosure is applied. The injection molding machine 1 is a casting device (so-called die casting machine) that executes casting by injecting a molten metal into a mold. FIG. 1 shows the injection molding machine 1 before the start of injection, and FIG. 2 shows the injection molding machine 1 immediately after the start of injection.

It should be noted that a right-handed XYZ orthogonal coordinate system shown in FIGS. 1 and 2 is for convenience in showing a positional relationship between the components. The Z direction is a vertical direction, the XY plane is a horizontal plane, and the X direction, the Y direction, and the Z direction are common to the drawings.

As shown in FIGS. 1 and 2, the injection molding machine 1 includes a mold 11, a plunger sleeve 12, and a plunger 13.

The mold 11 includes a movable mold 111 and a fixed mold 112. The movable mold 111 and the fixed mold 112 are tightened to each other to form a cavity C which is a hollow space. The fixed mold 112 is provided with an opening portion communicating with the cavity C. The opening portion of the fixed mold 112 forms a gate which is an inlet of the cavity C and a runner which is a flow passage of a molten metal M from the outside of the mold 11 to the gate. The molten metal M is, for example, a molten metal of aluminum.

The plunger sleeve 12 is a cylindrical member. In the examples of FIGS. 1 and 2, the plunger sleeve 12 is disposed to extend in the X direction. An opening portion 12a for supplying the molten metal M from the outside to the inside of the plunger sleeve 12 is provided on an upper surface of the plunger sleeve 12. In addition, an injection port 12b for injecting the molten metal M from the inside to the outside of the plunger sleeve 12 is provided at a front end portion of the plunger sleeve 12. The plunger sleeve 12 and the fixed mold 112 are connected to each other such that the injection port 12b of the plunger sleeve 12 and the opening portion of the fixed mold 112 communicate with each other. Further, a fitting port into which the plunger 13 is fitted is provided at a rear end portion of the plunger sleeve 12.

The plunger 13 is a rod-like member that is fitted into the plunger sleeve 12 from the fitting port provided at the rear end portion of the plunger sleeve 12. The plunger 13 is configured to slidably move in the plunger sleeve 12. In the examples of FIGS. 1 and 2, the plunger 13 is configured to slidably move in the plunger sleeve 12 in the X direction. For example, as shown in FIG. 2, the plunger 13 moves (forwards) to a negative side in the X direction in the plunger sleeve 12 from a state of the injection molding machine 1 before the start of injection shown in FIG. 1. As a result, the molten metal M in the plunger sleeve 12 is injected from the injection port 12b to the cavity C.

Specifically, the plunger 13 includes a plunger tip 131 and a plunger rod 132. The plunger tip 131 is a cylindrical member having a cross-sectional shape along an inner surface of the plunger sleeve 12, and is fitted into the plunger sleeve 12 from the fitting port provided at the rear end portion of the plunger sleeve 12. One end surface of the plunger tip 131 is a surface in contact with the molten metal M supplied into the plunger sleeve 12. The other end surface of the plunger tip 131 is connected to a tip part of the rod-like plunger rod 132. A rear end portion of the plunger rod 132 is connected to a drive mechanism (not shown).

The drive mechanism (not shown) moves the plunger rod 132 in the X direction, whereby the plunger tip 131 slidably moves in the plunger sleeve 12 in the X direction. For example, as shown in FIG. 2, the drive mechanism (not shown) moves (forwards) the plunger rod 132 to the negative side in the X direction from the state of the injection molding machine 1 before the start of injection shown in FIG. 1. As a result, the plunger tip 131 slidably moves (forwards) in the plunger sleeve 12 to the negative side in the X direction. As a result, the molten metal M in the plunger sleeve 12 is injected from the injection port 12b to the cavity C.

It should be noted that the drive mechanism that drives the plunger 13 is, for example, a hydraulic cylinder that controls a drive output via a servo valve. A cylinder rod of the hydraulic cylinder is coupled to a base end of the plunger rod 132 via a coupling. However, the drive mechanism that drives the plunger 13 is not limited to the hydraulic cylinder, and may be any mechanism as long as it is the following mechanism. That is, the drive mechanism may be any mechanism as long as it is a mechanism that has a control of slidably moving the plunger 13 in the X direction and that has a driving force for injecting the molten metal M in the plunger sleeve 12 to the cavity C via the plunger 13.

After the molten metal M in the plunger sleeve 12 is injected to the cavity C and filled, the molten metal M filled in the cavity C is solidified to form a molded product P. Thereafter, the movable mold 111 is moved to the negative side in the X direction, and thus the mold 11 is opened. In addition, the molded product P is demolded from the fixed mold 112 by further moving (forwards) the plunger 13 to the negative side in the X direction. After the molded product P is taken out from the mold 11, the plunger 13 is moved (retracted) to a positive side in the X direction to return to a position (injection start position) before the start of injection. In addition, the movable mold 111 is moved to the positive side in the X direction to return to the position before the start of injection. That is, the mold 11 returns to the tightened state. Thereafter, the molten metal M used for providing the next molded product P is supplied into the plunger sleeve 12 via the opening portion 12a. In the injection molding machine 1, such processing is repeated.

In general, the injection is performed at a low speed from the start of the extrusion of the molten metal M in the plunger sleeve 12 by the plunger 13 until the air is exhausted from the plunger sleeve 12 and the plunger sleeve 12 is filled with the molten metal M. Preferably, the injection is performed at a low speed from the start of the extrusion of the molten metal M in the plunger sleeve 12 by the plunger 13 until the molten metal M reaches the gate of the mold 11. Thereafter, the injection is performed at a high speed until the cavity C is filled with the molten metal M.

Here, the injection molding machine 1 is further provided with an acceleration sensor S. In the examples of FIGS. 1 and 2, the acceleration sensor S is attached in the vicinity of the tip part of the plunger rod 132. As a result, the acceleration sensor S can prevent deterioration due to the heat of the molten metal M as compared to a case of being attached to the plunger tip 131. However, the acceleration sensor S may be attached to the plunger tip 131. In this case, the acceleration sensor S can detect the acceleration with higher accuracy as compared to a case of being attached to the plunger rod 132.

The acceleration sensor S is a sensor capable of detecting an acceleration in three axial directions. For example, the acceleration sensor S detects an acceleration of the plunger 13 in the traveling direction (X direction) during the injection operation or an acceleration of the plunger 13 in a direction (direction parallel to the YZ plane) perpendicular to the traveling direction of the plunger 13 during the injection operation.

The acceleration sensor S may continuously measure the acceleration during a period from the start of the injection to the completion of the injection, or may measure the acceleration at any timing. That is, the acceleration sensor S may continuously measure the acceleration while the plunger tip 131 for advances in the plunger sleeve 12 from the injection start position to the injection completion position and then retract to the injection start position. The acceleration sensor S may measure the acceleration at any timing. The injection start position is a position at which the plunger tip 131 starts to extrude the molten metal M in the plunger sleeve 12, and the injection completion position is a position at which the injection of the molten metal M to the cavity C is completed.

In the present disclosure, the acceleration is measured by the acceleration sensor S during a low-speed injection period from the start of the extrusion of the molten metal M in the plunger sleeve 12 by the plunger 13 until the air is exhausted from the plunger sleeve 12 and the plunger sleeve 12 is filled with the molten metal M. Preferably, the acceleration is measured by the acceleration sensor S during a low-speed injection period from the start of the extrusion of the molten metal M in the plunger sleeve 12 by the plunger 13 until the air is exhausted from the plunger sleeve 12 and the plunger sleeve 12 is filled with the molten metal M.

The injection molding machine 1 may be provided with another sensor capable of detecting the acceleration of the plunger 13 in the traveling direction (X direction) during the injection operation, instead of the acceleration sensor S. The injection molding machine 1 may be provided with another sensor capable of detecting the acceleration of the plunger 13 in the direction (direction parallel to the YZ plane) perpendicular to the traveling direction of the plunger 13 during the injection operation.

Meanwhile, the injection molding machine 1 is required to detect various abnormalities that affect the injection of the molten metal by the plunger 13 and to quickly repair the abnormalities in order to provide a high-quality molded product. Here, the abnormality that affects the injection of the molten metal by the plunger 13 includes not only the galling but also an abnormality of a drive mechanism that drives the plunger. However, in the related art, there is a problem in that an abnormality other than the galling, among the abnormalities that affect the injection of the molten metal by the plunger 13, cannot be detected.

Therefore, the monitoring device according to the present disclosure uses a phenomenon in which the drive mechanism continuously applies a vibration having a predetermined frequency to the plunger 13 in a case where an abnormality occurs in the drive mechanism that drives the plunger 13. The monitoring device monitors the presence or absence of the abnormality in the drive mechanism based on acceleration information in the traveling direction of the plunger 13 by using the phenomenon. As a result, the monitoring device according to the present disclosure can detect an abnormality other than galling, among the abnormalities that affect the injection of the molten metal by the plunger 13. That is, the monitoring device according to the present disclosure can specify the location where various abnormalities that affect the injection of the molten metal by the plunger occur. Since the injection molding machine 1 can perform the repair of the abnormality location as necessary based on the monitoring result of the monitoring device, a high-quality molded product can be provided. Hereinafter, a configuration of the monitoring device according to the present disclosure will be described.

### Configuration of Monitoring Device 2

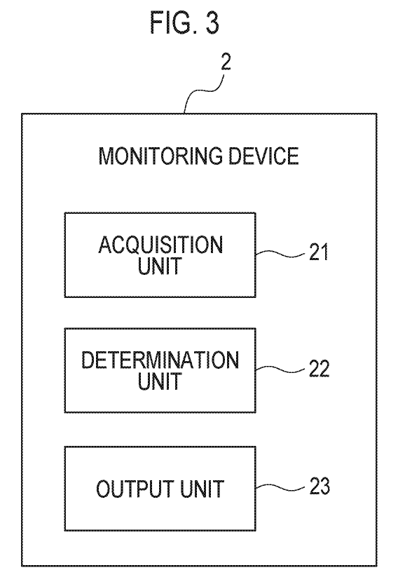

FIG. 3 is a block diagram showing a configuration example of the monitoring device 2 according to the present disclosure. The monitoring device 2 is a device that monitors the injection molding machine 1. In particular, the monitoring device 2 monitors the presence or absence of an abnormality in the drive mechanism (in the present example, the hydraulic cylinder) that drives the plunger 13. In addition, the monitoring device 2 monitors the presence or absence of galling (abrasion) of the plunger sleeve 12 or the plunger 13 and the presence or absence of floating.

It should be noted that the galling refers to an abrasion portion of the plunger sleeve 12 or the plunger 13. In a case where the abrasion progresses and the molten metal enters the abrasion portion and solidifies, there is a possibility that the smooth movement of the plunger 13 in the plunger sleeve 12 is not performed due to friction of the solidified molten metal. The floating is a state in which the smooth movement of the plunger 13 in the plunger sleeve 12 is not performed due to a defect in connection via the coupling between the cylinder rod of the hydraulic cylinder and the base end of the plunger rod 132.

As shown in FIG. 3, the monitoring device 2 includes an acquisition unit 21, a determination unit 22, and an output unit 23.

The acquisition unit 21 acquires the acceleration information of the plunger 13 during the injection operation detected by the acceleration sensor S via a wired or wireless network. The acceleration information of the plunger 13 includes information on the acceleration of the plunger 13 in the traveling direction (X direction) during the injection operation and information on the acceleration of the plunger 13 in the direction (direction parallel to the YZ plane) perpendicular to the traveling direction of the plunger 13 during the injection operation.

The determination unit 22 determines the presence or absence of the abnormality in the drive mechanism that drives the plunger 13 based on the information on the acceleration of the plunger 13 in the traveling direction (X direction) among pieces of the acquired acceleration information.

For example, in a case where a variation width of the acceleration of the plunger 13 in the traveling direction is equal to or less than a first predetermined value, the determination unit 22 determines that no abnormality in the drive mechanism that drives the plunger 13 has occurred. The variation width of the acceleration of the plunger 13 in the traveling direction is an amplitude of a waveform representing the acceleration of the plunger 13 in the traveling direction, that is, a vibration in the traveling direction of the plunger 13. It should be noted that the first predetermined value may be set with, for example, a variation width of the acceleration acquired in a case where the injection is normally performed as a reference. Alternatively, the first predetermined value may be set with an average value of the accelerations acquired in an acceleration measurement period as a reference. The first predetermined value may be fixed or may be changed in accordance with a change in the reference value.

On the other hand, in a case where the variation width of the acceleration of the plunger 13 in the traveling direction exceeds the first predetermined value, there is a possibility that there is an abnormality in the drive mechanism that drives the plunger 13. Therefore, next, the determination unit 22 performs frequency analysis on the acceleration of the plunger 13 in the traveling direction.

For example, in a case where a component of a predetermined frequency (for example, about 40 Hz) is detected from the variation frequency of the acceleration of the plunger 13 in the traveling direction, the determination unit 22 determines that there is an abnormality in the drive mechanism that drives the plunger 13. On the other hand, in a case where the component of the predetermined frequency is not detected from the variation frequency of the acceleration of the plunger 13 in the traveling direction, the determination unit 22 determines that there is an abnormality in the drive mechanism that drives the plunger 13. It should be noted that the predetermined frequency is set to a value in accordance with an injection condition or the like of the injection molding machine 1.

More preferably, in a case where the component of the predetermined frequency is continuously detected from the variation frequency of the acceleration of the plunger 13 in the traveling direction in the acceleration measurement period, the determination unit 22 determines that there is an abnormality in the drive mechanism that drives the plunger 13. The acceleration measurement period may be the low-speed injection period in the present example. The predetermined frequency may be, for example, about 40 Hz. On the other hand, in a case where the component of the predetermined frequency is not detected from the variation frequency of the acceleration of the plunger 13 in the traveling direction in the acceleration measurement period, the determination unit 22 determines that there is an abnormality in the drive mechanism that drives the plunger 13. Alternatively, in a case where the component of the predetermined frequency is detected from the variation frequency of the acceleration of the plunger 13 in the traveling direction only during a part of the acceleration measurement period, the determination unit 22 determines that there is an abnormality in the drive mechanism that drives the plunger 13.

Further, the determination unit 22 may determine the presence or absence of the galling of the plunger sleeve 12 or the plunger 13 and the presence or absence of the floating based on the information on the acceleration of the plunger 13 in the direction perpendicular to the traveling direction among pieces of the acquired acceleration information. The direction perpendicular to the traveling direction of the plunger 13 is the direction parallel to the YZ plane.

For example, in a case where a variation width of the acceleration of the plunger 13 in the direction perpendicular to the traveling direction is equal to or less than a second predetermined value, the determination unit 22 determines that neither of the galling abnormality nor the floating abnormality has occurred. The variation width of the acceleration of the plunger 13 in the direction perpendicular to the traveling direction is an amplitude of a waveform representing the acceleration of the plunger 13 in the direction perpendicular to the traveling direction, that is, a vibration in the direction perpendicular to the traveling direction of the plunger 13. On the other hand, in a case where the variation width of the acceleration of the plunger 13 in the direction perpendicular to the traveling direction exceeds the second predetermined value, the determination unit 22 determines that either the galling abnormality or the floating abnormality has occurred. In a case where either the galling abnormality or the floating abnormality has occurred, there is a possibility that the injection molding machine 1 cannot realize an accurate injection operation, and in this case, there is a possibility that a defective molded product P is formed.

The second predetermined value may be set with, for example, a variation width of the acceleration acquired in a case where the injection is normally performed as a reference. Alternatively, the second predetermined value may be set with an average value of the accelerations acquired in the acceleration measurement period as a reference. The second predetermined value may be fixed or may be changed in accordance with a change in the reference value.

The determination unit 22 may consider not only the variation width (amplitude) of the acceleration of the plunger 13 in the direction perpendicular to the traveling direction but also the variation frequency (frequency) of the acceleration of the plunger 13 in the direction perpendicular to the traveling direction. The determination unit 22 may determine the presence or absence of the galling and the presence or absence of the floating in consideration of these factors. For example, the following determination may be performed in a case where the variation width (amplitude) of the acceleration of the plunger 13 in the direction perpendicular to the traveling direction exceeds the second predetermined value and a second predetermined frequency is included in the variation frequency (frequency) of the acceleration of the plunger 13 in the direction perpendicular to the traveling direction. That is, in such cases, the determination unit 22 may determine that either the galling abnormality or the floating abnormality has occurred.

The second predetermined frequency may be set with, for example, a variation frequency of the acceleration acquired in a case where the injection is normally performed as a reference. Alternatively, the second predetermined frequency may be set with an average value of the variation frequencies of the accelerations acquired in the acceleration measurement period as a reference.

The output unit 23 outputs the determination result of the determination unit 22 as the monitoring result of the monitoring device 2. The determination result of the determination unit 22 is displayed on, for example, a monitor (not shown). As a result, a manager of the injection molding machine 1 can refer to the determination result displayed on the monitor and perform the repair of the drive mechanism in which the abnormality has occurred, as necessary. The manager of the injection molding machine 1 can refer to the determination result displayed on the monitor and perform the repair of the plunger sleeve 12 or the plunger 13 in which the galling has occurred, as necessary. The manager of the injection molding machine 1 can refer to the determination result displayed on the monitor and perform the repair of the coupling in which the floating has occurred, as necessary.

Alternatively, the output unit 23 may be configured to output an instruction in accordance with the determination result of the determination unit 22 to a controller (not shown) of the injection molding machine 1. For example, in a case where it is determined that any abnormality has occurred in the injection molding machine 1, the output unit 23 outputs an instruction to stop the injection operation to the controller of the injection molding machine 1. As a result, the controller of the injection molding machine 1 stops the injection operation of the injection molding machine 1 in response to the instruction from the monitoring device 2. After the injection operation of the injection molding machine 1 is stopped, the manager of the injection molding machine 1 can perform the repair of the abnormality location of the injection molding machine 1. It should be noted that the monitoring device 2 may be used as a part of the controller of the injection molding machine 1.

### Experiment Result

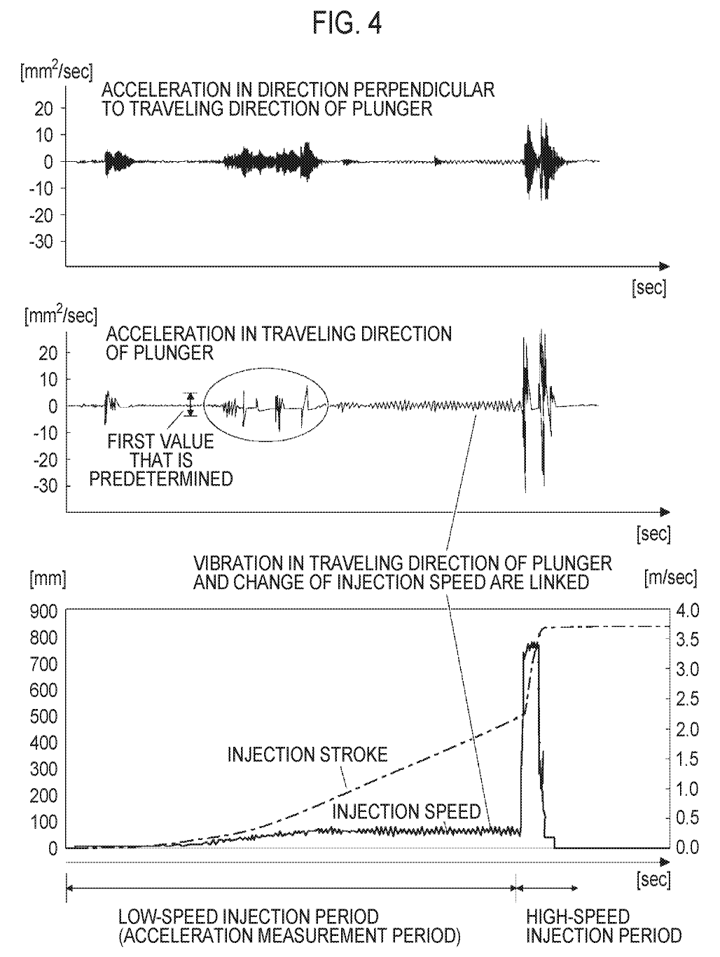

Subsequently, an experiment result of the injection operation of the injection molding machine 1 will be described with reference to FIGS. 4 to 9. It should be noted that a component of the gravitational acceleration in the acceleration of the plunger 13 is not considered.

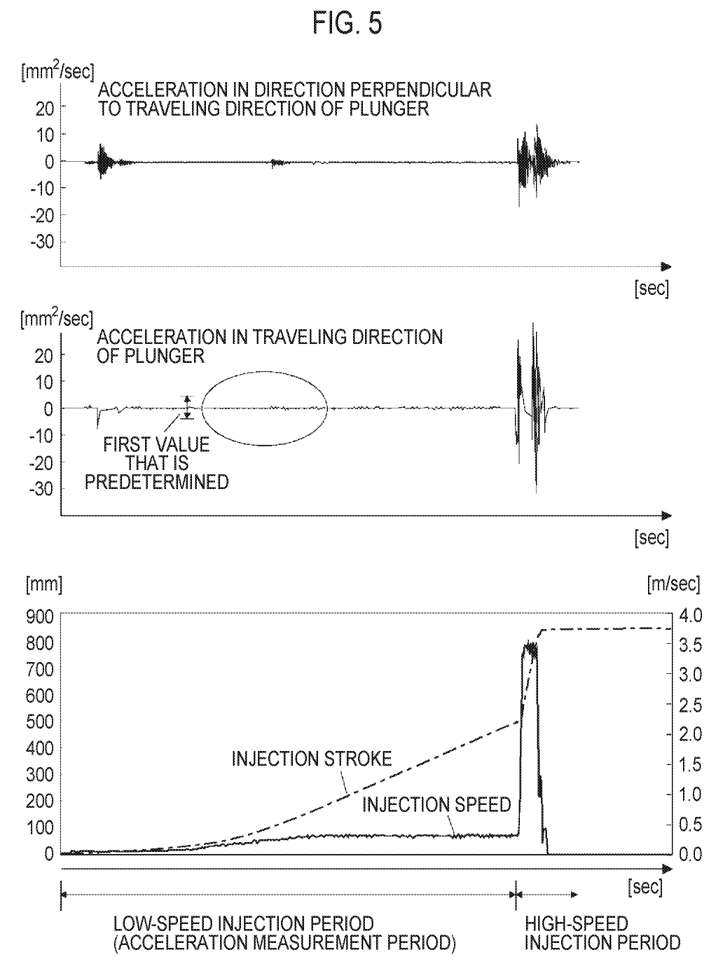

FIG. 4 is a waveform diagram showing the acceleration of the plunger 13 in a case where there is an abnormality in the drive mechanism. FIG. 5 is a waveform diagram showing the acceleration of the plunger 13 in a case where there is no abnormality in the drive mechanism. FIGS. 4 and 5 also show a stroke of the plunger 13 (distance from the injection start position of the plunger 13) and a movement speed of the plunger 13.

In the example of FIG. 4, the injection speed is slightly changed in the low-speed injection period. In addition, in the example of FIG. 4, among the vibration of the acceleration of the plunger 13 in the traveling direction and the vibration of the acceleration of the plunger 13 in the direction perpendicular to the traveling direction, the vibration of the acceleration of the plunger 13 in the traveling direction is linked with the slight change in the injection speed. That is, the slight change in the injection speed is caused by the vibration of the acceleration of the plunger 13 in the traveling direction. Here, as shown in FIG. 4, before the drive mechanism is repaired, the vibration of the acceleration of the plunger 13 in the traveling direction is larger than the first predetermined value. On the other hand, as shown in FIG. 5, after the drive mechanism is repaired, the vibration of the acceleration of the plunger 13 in the traveling direction is suppressed to be equal to or less than the first predetermined value. As described above, in a case where there is an abnormality in the drive mechanism, the variation of the acceleration of the plunger 13 in the traveling direction is larger than in a case where there is no abnormality in the drive mechanism.

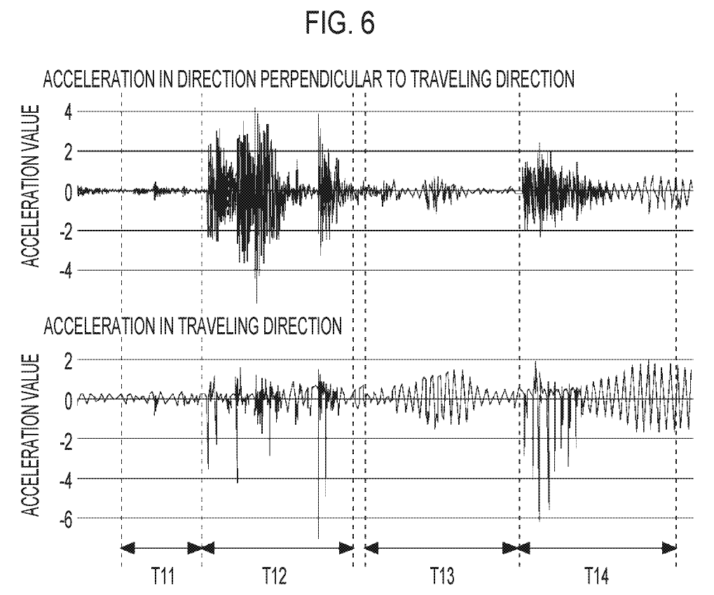

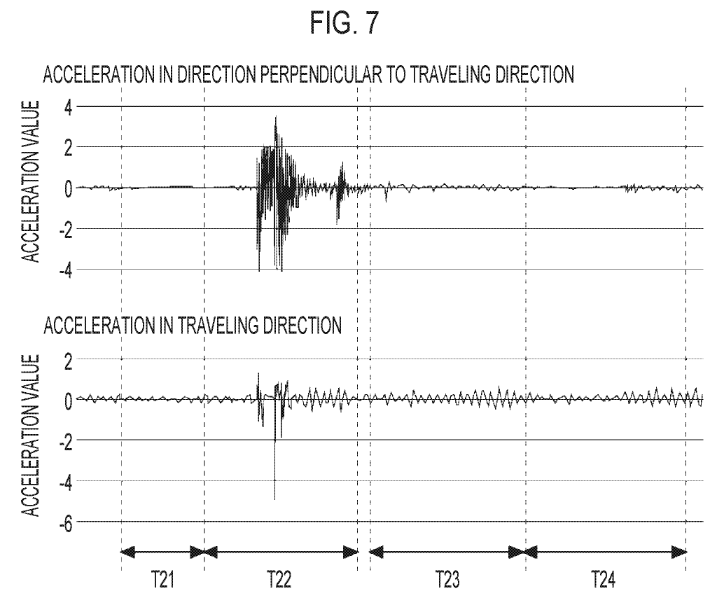

FIG. 6 is an enlarged waveform diagram showing a part of the acceleration of the plunger 13 in a case where there is an abnormality in the drive mechanism. FIG. 7 is an enlarged waveform diagram showing a part of the acceleration of the plunger 13 in a case where there is no abnormality in the drive mechanism. FIGS. 6 and 7 show a waveform diagram of a part of the low-speed injection period.

In a case of comparing FIGS. 6 and 7, the variation width of the acceleration of the plunger 13 in the direction perpendicular to the traveling direction is substantially the same regardless of the presence or absence of the abnormality in the drive mechanism. On the other hand, the variation width of the acceleration of the plunger 13 in the traveling direction is larger in a case where there is an abnormality in the drive mechanism than in a case where there is no abnormality in the drive mechanism.

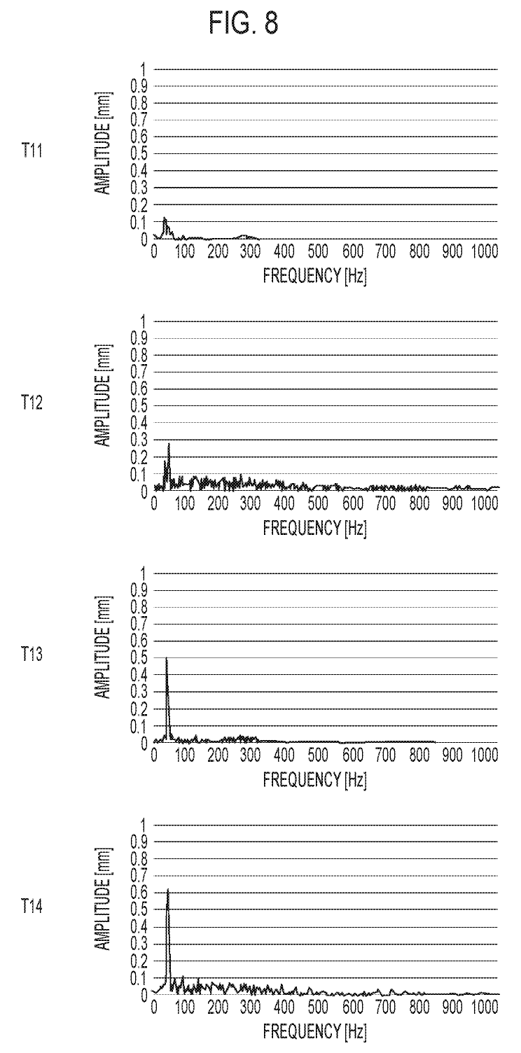

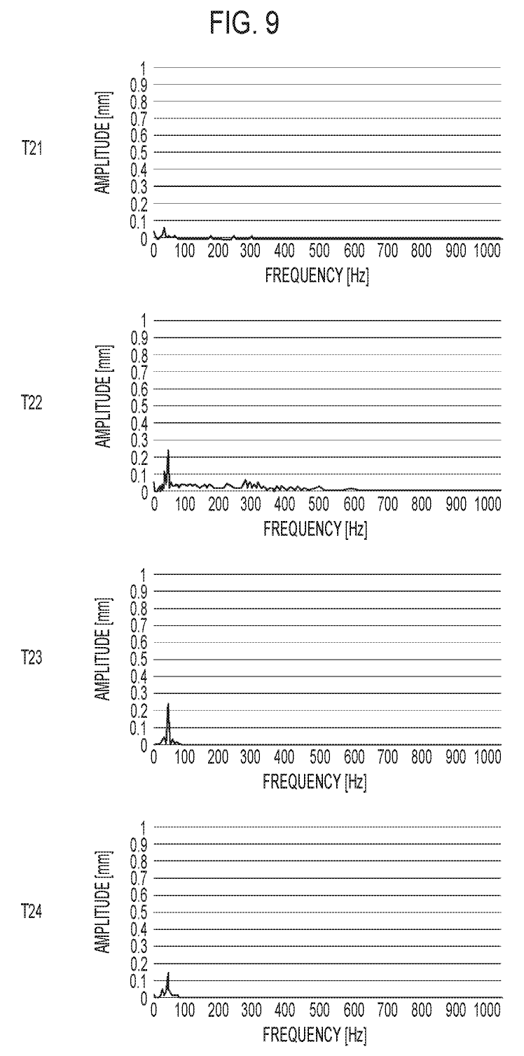

FIG. 8 is a diagram showing the frequency spectrum of each of acceleration measurement periods T11 to T14 in a case where there is an abnormality in the drive mechanism. FIG. 9 is a diagram showing the frequency spectrum of each of acceleration measurement periods T21 to T24 in a case where there is no abnormality in the drive mechanism. The acceleration measurement periods T11 to T14 of FIG. 8 correspond to the acceleration measurement periods T11 to T14 of FIG. 6. The acceleration measurement periods T21 to T24 of FIG. 9 correspond to the acceleration measurement periods T21 to T24 of FIG. 7.

As shown in FIG. 8, in a case where there is an abnormality in the drive mechanism, the component of the predetermined frequency is consistently detected from the variation frequency of the acceleration of the plunger 13 in the traveling direction in the acceleration measurement periods T11 to T14. In the example of FIG. 8, a predetermined frequency component of about 40 Hz having an amplitude of 0.1 mm or more is continuously detected in all of the acceleration measurement periods T11 to T14. In addition, in most of the acceleration measurement periods T11 to T14 (periods from T12 to T14), the predetermined frequency component of about 40 Hz having an amplitude of about 0.3 mm or more is detected. On the other hand, as shown in FIG. 9, in a case where there is no abnormality in the drive mechanism, the predetermined frequency component is not continuously detected from the variation frequency of the acceleration of the plunger 13 in the traveling direction in the acceleration measurement periods T21 to T24. In the example of FIG. 9, the predetermined frequency component of about 40 Hz having an amplitude of 0.1 mm or more is detected only in the period from T22 to T24 among the acceleration measurement periods T21 to T24. In addition, in none of the acceleration measurement periods T21 to T24, the predetermined frequency component of about 40 Hz having an amplitude of about 0.3 mm or more is not detected. As described above, in a case where there is an abnormality in the drive mechanism, a predetermined frequency component having a large amplitude is continuously detected from the variation frequency of the acceleration of the plunger 13 in the traveling direction as compared to a case where there is no abnormality in the drive mechanism.

### Operation of Monitoring Device 2

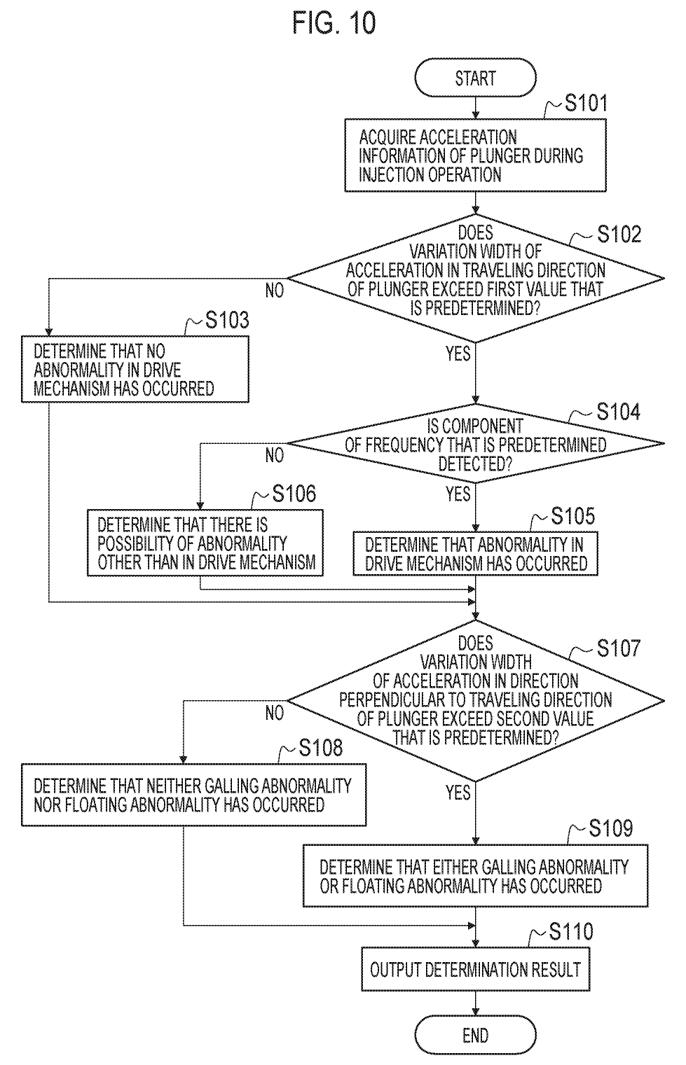

Subsequently, an operation of the monitoring device 2 will be described with reference to FIG. 10. FIG. 10 is a flowchart showing the operation of the monitoring device 2.

First, the monitoring device 2 acquires the acceleration information of the plunger 13 during the injection operation detected by the acceleration sensor S (S101). The acceleration information of the plunger 13 includes information on the acceleration of the plunger 13 in the traveling direction (X direction) during the injection operation and information on the acceleration of the plunger 13 in the direction (direction parallel to the YZ plane) perpendicular to the traveling direction of the plunger 13 during the injection operation.

Then, the monitoring device 2 determines the presence or absence of the abnormality in the drive mechanism that drives the plunger 13 based on the acceleration information in the traveling direction of the plunger 13 (S102).

For example, in a case where the variation width of the acceleration of the plunger 13 in the traveling direction is equal to or less than the first predetermined value (NO in S102), the monitoring device 2 determines that no abnormality in the drive mechanism that drives the plunger 13 has occurred (S103). On the other hand, in a case where the variation width of the acceleration of the plunger 13 in the traveling direction exceeds the first predetermined value (YES in S102), there is a possibility that there is an abnormality in the drive mechanism that drives the plunger 13. Therefore, next, the monitoring device 2 performs the frequency analysis on the acceleration of the plunger 13 in the traveling direction (S104).

For example, in a case where the component of the predetermined frequency is continuously detected from the variation frequency of the acceleration of the plunger 13 in the traveling direction in the acceleration measurement period (YES in S104), the monitoring device 2 performs the following determination. The acceleration measurement period is the low-speed injection period in the present example. The predetermined frequency is, for example, about 40 Hz. In a case where the component of the predetermined frequency is detected (YES in S104), the monitoring device 2 determines that there is an abnormality in the drive mechanism that drives the plunger 13 (S105). On the other hand, in a case where the component of the predetermined frequency is not detected from the variation frequency of the acceleration of the plunger 13 in the traveling direction in the acceleration measurement period (NO in S104), the monitoring device 2 performs the following determination. In a case where the component of the predetermined frequency is not detected (NO in S104), the monitoring device 2 determines that there is an abnormality other than in the drive mechanism that drives the plunger 13 (S106). Alternatively, in a case where the component of the predetermined frequency is detected from the variation frequency of the acceleration of the plunger 13 in the traveling direction only during a part of the acceleration measurement period (NO in S104), the monitoring device 2 performs the following determination. That is, the monitoring device 2 determines that there is an abnormality other than in the drive mechanism that drives the plunger 13 (S106).

Then, the monitoring device 2 determines the presence or absence of the galling of the plunger sleeve 12 or the plunger 13 and the presence or absence of the floating based on the acceleration information in the direction perpendicular to the traveling direction of the plunger 13 (S107).

For example, in a case where the variation width of the acceleration of the plunger 13 in the direction perpendicular to the traveling direction is equal to or less than the second predetermined value (NO in S107), the monitoring device 2 determines that neither of the galling nor the floating has occurred (S108). On the other hand, in a case where the variation width of the acceleration of the plunger 13 in the direction perpendicular to the traveling direction exceeds the second predetermined value (YES in S107), the monitoring device 2 determines that either the galling abnormality or the floating abnormality has occurred (S109).

Then, the monitoring device 2 outputs the determination result (S110). The determination result is displayed on, for example, the monitor (not shown). As a result, the manager of the injection molding machine 1 can refer to the determination result displayed on the monitor and perform the repair of the injection molding machine 1, as necessary.

Alternatively, the monitoring device 2 may output the instruction in accordance with the determination result to the controller (not shown) of the injection molding machine 1. For example, in a case where it is determined that any abnormality has occurred in the injection molding machine 1, the monitoring device 2 outputs an instruction to stop the injection operation to the controller of the injection molding machine 1. As a result, the controller of the injection molding machine 1 stops the injection operation of the injection molding machine 1 in response to the instruction from the monitoring device 2. After the injection operation of the injection molding machine 1 is stopped, the manager of the injection molding machine 1 can perform the repair of the abnormality location of the injection molding machine 1. It should be noted that the monitoring device 2 may be used as a part of the controller of the injection molding machine 1.

As described above, the monitoring device 2 according to the present disclosure uses the phenomenon in which the drive mechanism continuously applies the vibration having the predetermined frequency to the plunger 13 in a case where the abnormality occurs in the drive mechanism that drives the plunger 13. The monitoring device 2 monitors the presence or absence of the abnormality in the drive mechanism based on the acceleration information in the traveling direction of the plunger 13 by using the phenomenon. As a result, the monitoring device 2 according to the present disclosure can detect an abnormality other than galling, among the abnormalities that affect the injection of the molten metal by the plunger 13. That is, the monitoring device 2 according to the present disclosure can specify the location where various abnormalities that affect the injection of the molten metal by the plunger 13 occur. Since the injection molding machine 1 can perform the repair of the abnormality location as necessary based on the monitoring result of the monitoring device 2, the high-quality molded product P can be formed.

The present disclosure can be implemented by causing a central processing unit (CPU) to execute a computer program, which performs a part or all of processing in the monitoring device 2 or the injection molding machine 1 equipped with the monitoring device 2.

The program described above includes an instruction group (or software code) for causing a computer to execute one or more functions described in the embodiment in a case where the program is read into the computer. The program may be stored on a non-transitory computer-readable medium or a tangible storage medium. Examples of the non-transitory computer-readable medium or the tangible storage medium include a random-access memory (RAM), a read-only memory (ROM), a flash memory, a solid-state drive (SSD), or other memory technologies, without limitation. Examples of the computer-readable medium or the tangible storage medium include a CD-ROM, a digital versatile disc (DVD), a Blu-ray (registered trademark) disc, or other optical disc storage, without limitation. Examples of the computer-readable medium or the tangible storage medium include a magnetic cassette, a magnetic tape, a magnetic disk storage, or other magnetic storage devices, without limitation. The program may be transmitted on a transitory computer-readable medium or a communication medium. Examples of the transitory computer-readable medium or the communication medium include electrical, optical, acoustic, or other forms of propagating signals, but the transitory computer-readable medium or the communication medium is not limited to these examples.

Although the present disclosure has been described referring to the embodiment, the present disclosure is not limited to the above-described embodiment. Those skilled in the art can make various modifications and details within the scope of the present disclosure to the configurations or the details of the present disclosure. Each embodiment can be combined with other embodiments as appropriate.

What is claimed is:

1. A monitoring device comprising:
an acquisition unit configured to acquire acceleration information of a plunger during an injection operation;
a determination unit configured to determine presence of an abnormality in a drive mechanism that drives the plunger when both of following conditions are satisfied:
a variation width of an acceleration of the plunger in a traveling direction exceeds a value that is predetermined, and
a variation frequency of the acceleration of the plunger in the traveling direction includes a component of a frequency that is predetermined; and
an output unit configured to output a determination result of the determination unit.

2. The monitoring device according to claim 1, wherein the determination unit is configured to determine presence of the abnormality in the drive mechanism that drives the plunger when both of following conditions are satisfied:
the variation width of the acceleration of the plunger in the traveling direction exceeds the value that is predetermined, and
during an acceleration measurement period, the variation frequency of the acceleration of the plunger in the traveling direction continuously includes the component of the frequency that is predetermined.

3. The monitoring device according to claim 2, wherein the determination unit is configured to determine presence of an abnormality other than in the drive mechanism that drives the plunger when either of following conditions is satisfied even when the variation width of the acceleration of the plunger in the traveling direction exceeds the value that is predetermined:
the variation frequency of the acceleration of the plunger in the traveling direction includes the component of the frequency that is predetermined only during a part of the acceleration measurement period, or
during the acceleration measurement period, the variation frequency of the acceleration of the plunger in the traveling direction does not include the component of the frequency that is predetermined.

4. The monitoring device according to claim 1, wherein the determination unit is configured to further determine presence or absence of galling of at least either a plunger sleeve or the plunger based on information on an acceleration in a direction perpendicular to the traveling direction of the plunger among the acceleration information.

5. A monitoring method comprising:
acquiring acceleration information of a plunger during an injection operation;
determining presence of an abnormality in a drive mechanism that drives the plunger when both of following conditions are satisfied:
a variation width of an acceleration of the plunger in a traveling direction exceeds a value that is predetermined, and
a variation frequency of the acceleration of the plunger in the traveling direction includes a component of a frequency that is predetermined; and
outputting a result of the determining.
